(19) United States
(12) Patent Application Publication
(10) Pub. No.: US 2026/0243210 A1
(43) Pub. Date: Aug. 20, 2026

(54) CATALYST TEMPERATURE ESTIMATION APPARATUS

(71) Applicant: Honda Motor Co., Ltd., Tokyo (JP)

(72) Inventors: Ken Matsui, Tokyo (JP); Toshiyuki Nakamura, Tokyo (JP); Toshiaki Ichoda, Tokyo (JP)

(21) Appl. No.: 19/538,911

(22) Filed: Feb. 12, 2026

(30) Foreign Application Priority Data
Feb. 19, 2025 (JP) 2025-025032

(51) Int. Cl. F02D 41/02; F02D 41/12

(52) U.S. Cl. CPC F02D 41/029; F02D 41/024; F02D 41/123

(57) ABSTRACT

A catalyst temperature estimation apparatus estimating a catalyst temperature of an exhaust gas purification device, the exhaust gas purification device being disposed in an exhaust passage of an internal combustion engine. The internal combustion engine includes an injector injecting a fuel and having a function of a fuel cut configured to shut off a fuel injection from the injector while a vehicle is traveling. The catalyst temperature estimation apparatus includes a microprocessor, and the microprocessor is configured to perform acquiring a parameter representing an operation state of the internal combustion engine, and obtaining an estimated value of the catalyst temperature based on the parameter, wherein the obtaining includes maintaining the estimated value at a start of the fuel cut until the operation state after the fuel cut becomes a predetermined operation state when the fuel cut is executed.

### CROSS-REFERENCE TO RELATED APPLICATION

This application is based upon and claims the benefit of priority from Japanese Patent Application No. 2025-025032 filed on February 19, 2025, the content of which is incorporated herein by reference.

### BACKGROUND OF THE INVENTION

### Field of the Invention

This invention relates to a catalyst temperature estimation apparatus estimating a temperature of an exhaust catalyst device.

### Description of the Related Art

In recent years, efforts aimed at mitigating or reducing the impacts of climate change have continued, and research and development related to exhaust gas purification devices have been conducted to achieve this. As technology related to this type of exhaust gas purification device, there is a known apparatus that estimates the temperature (catalyst temperature) of an exhaust gas purification device during fuel cut. Such an apparatus is described in, for example, Japanese Unexamined Patent Publication No. 2003-278583 (JP2003-278583A). In the apparatus described in JP2003-278583A, the catalyst temperature is estimated based on an intake air amount and engine speed during fuel cut and non-fuel cut.

However, in the arrangement of estimating the catalyst temperature based on the intake air amount and engine speed like the device described in JP2003-278583A, it is difficult to accurately estimate the catalyst temperature after fuel cut.

### SUMMARY OF THE INVENTION

An aspect of the present invention is a catalyst temperature estimation apparatus estimating a catalyst temperature of an exhaust gas purification device, the exhaust gas purification device being disposed in an exhaust passage of an internal combustion engine, the internal combustion engine including an injector injecting a fuel and having a function of a fuel cut configured to shut off a fuel injection from the injector while a vehicle is traveling. The catalyst temperature estimation apparatus includes an electronic control unit including a microprocessor and a memory connected to the microprocessor, wherein the microprocessor is configured to perform acquiring a parameter representing an operation state of the internal combustion engine, and obtaining an estimated value of the catalyst temperature based on the parameter, the obtaining including maintaining the estimated value at a start of the fuel cut until the operation state after the fuel cut becomes a predetermined operation state when the fuel cut is executed.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating a configuration of a main part of an engine to which a catalyst temperature estimation apparatus according to an embodiment of the present invention is applied;

FIG. 2 is a block diagram illustrating a configuration of a main part of a control apparatus for an internal combustion engine including the catalyst temperature estimation apparatus according to the embodiment of the present invention;

FIG. 3 is a diagram illustrating a relationship between an integrated intake air amount of the engine and a correction coefficient;

FIG. 4 is a time chart illustrating an example of a change of a catalyst temperature and the integrated intake air amount after a fuel cut;

FIG. 5 is a time chart illustrating an example of a change of the catalyst temperature after the fuel cut, corresponding to different operation states;

FIG. 6 is a flowchart illustrating an example of processing executed by a controller in FIG. 2; and

FIG. 7 is a time chart illustrating an example of a change of the catalyst temperature corresponding to a different integrated intake air amount before the fuel cut.

### DETAILED DESCRIPTION OF THE INVENTION

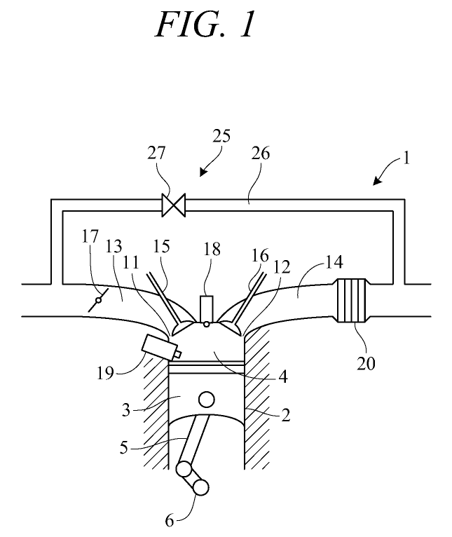

Hereinafter, an embodiment of the present invention will be described below with reference to FIGS. 1 to 7. A control apparatus for an internal combustion engine according to an embodiment of the present invention is applied to a vehicle equipped with a gasoline engine as an internal combustion engine. That is, the present invention is applied to an engine vehicle that travels using only an engine as a driving source and a hybrid vehicle that travels using an engine and a motor as driving sources.

FIG. 1 is a diagram schematically illustrating a configuration of a main part of an engine 1 which is an internal combustion engine to which a control apparatus according to the present embodiment is applied. The engine 1 is a spark ignition type internal combustion engine having a fuel cut function that stops the supply of fuel to multiple cylinders during vehicle deceleration, and is a four-stroke engine that undergoes four strokes of intake, compression, expansion, and exhaust during an operation cycle. The engine 1 includes a plurality of cylinders having the same configuration. FIG. 1 illustrates a configuration of a single cylinder.

As illustrated in FIG. 1, the engine 1 includes a cylinder 2 that is formed in a cylinder block, a piston 3 that is slidably disposed inside the cylinder 2, and a combustion chamber 4 that is formed between the piston 3 and a cylinder head. The piston 3 is coupled with a crankshaft 6 through a connecting rod 5, and the crankshaft 6 rotates as the piston 3 reciprocates along an inner wall of the cylinder 2.

An intake port 11 and an exhaust port 12 are provided on the cylinder head. The combustion chamber 4 communicates with an intake passage 13 through the intake port 11, and communicates with an exhaust passage 14 through the exhaust port 12. The intake port 11 is opened and closed by an intake valve 15, and the exhaust port 12 is opened and closed by an exhaust valve 16. A throttle valve 17 is provided in the intake passage 13 on an upstream side of the intake valve 15.

The throttle valve 17 includes, for example, a butterfly valve, and an intake air amount into the combustion chamber 4 is adjusted by the throttle valve 17. The throttle valve 17 is driven by a throttle actuator such as an electric motor according to an operation of an accelerator pedal. The intake valve 15 and the exhaust valve 16 are driven to be opened and closed at a predetermined timing synchronized with the rotation of the crankshaft 6 by a valve mechanism (not illustrated). The timing of opening and closing the valves 15 and 16 can be changed as appropriate.

An ignition plug 18 and a direct injection type of injector 19 are attached to either the cylinder head or the cylinder block (for example, the cylinder head) so as to face the combustion chamber 4 of the cylinder 2. The ignition plug 18 is disposed between the intake port 11 and the exhaust port 12, generates sparks by electric energy, and ignites an air-fuel mixture in the combustion chamber 4. The injector 19 is disposed in the vicinity of the intake valve 15 and is driven by electric energy to inject fuel obliquely downward into the combustion chamber 4. The arrangement of the injector 19 is not limited thereto, and the injector 19 may be disposed in the vicinity of the ignition plug 18.

An exhaust gas purification device 20 for purifying an exhaust gas is interposed in the exhaust passage 14. The exhaust gas purification device 20 is a three-way catalyst having a function of removing and purifying HC, CO, and NOx contained in the exhaust gas by an oxidation and reduction actions. Precious metals such as platinum are used in the catalyst. Other exhaust gas purification devices such as an oxidation catalyst for oxidizing CO and HC in the exhaust gas can also be used. When a temperature (catalyst temperature Tc) of the catalyst included in the exhaust gas purification device 20 increases, the catalyst is activated, and the purification action of the exhaust gas by the exhaust gas purification device 20 increases. However, when the catalyst temperature Tc becomes excessively high, the exhaust gas purification device 20 is damaged, so that the catalyst temperature Tc needs to be suppressed to a predetermined temperature (upper limit temperature T1) or less.

Further, the engine 1 further includes an exhaust gas recirculation device 25. The exhaust gas recirculation device 25 includes an EGR (Exhaust Gas Recirculation) passage 26 and an EGR valve 27 disposed in the EGR passage 26. One end of the EGR passage 26 is connected to the downstream side of the exhaust gas purification device 20 in the exhaust passage 14, and the other end is connected to the upstream side of the throttle valve 17 in the intake passage 13. The exhaust gas flowing through the exhaust passage 14 can be recirculated to the intake passage 13 through the EGR passage 21 and the EGR valve 27. The EGR valve 27 is driven by an EGR actuator such as an electric motor, and is configured to be adjustable in opening degree. The exhaust gas recirculation device 25 can be omitted.

The engine 1 has a fuel cut function of stopping fuel injection from the injector 19 when a predetermined fuel cut condition is satisfied during engine operation, for the purpose of improving fuel efficiency. That is, when the fuel cut condition is satisfied, a mode shifts to a fuel cut mode (referred to as an F/C mode), and the fuel injection is stopped. The fuel cut condition is satisfied, for example, when a state is detected in which an operation amount (accelerator opening) of an accelerator pedal is equal to or less than a predetermined value, a rotation speed (engine speed) of the crankshaft 6 is equal to or greater than a predetermined value, and a vehicle speed is equal to or greater than a predetermined value. For example, the fuel cut condition is satisfied during deceleration travel. The fuel cut condition is not limited to that described above.

In the F/C mode, the throttle valve 17 is substantially fully closed, but the intake of air into the cylinder 2 continues to a certain extent in order to suppress unstable combustion due to an insufficient intake air amount when returning from the F/C mode and to suppress shock due to a rapid change in the intake air amount. Therefore, even in the F/C mode, an integrated intake air amount (F/C integrated intake air amount) described later increases.

In such an engine 1, when the accelerator pedal is depressed to increase the accelerator opening, the throttle valve 17 is opened to increase the intake air amount. Accordingly, the exhaust gas temperature rises, and the catalyst temperature Tc rises accordingly. In order to suppress damage to the exhaust gas purification device 20, the engine 1 needs to be configured such that the catalyst temperature Tc does not exceed the upper limit temperature T1. For this purpose, it is necessary to accurately estimate the catalyst temperature Tc. In this regard, in the present embodiment, a catalyst temperature estimation apparatus is configured as follows.

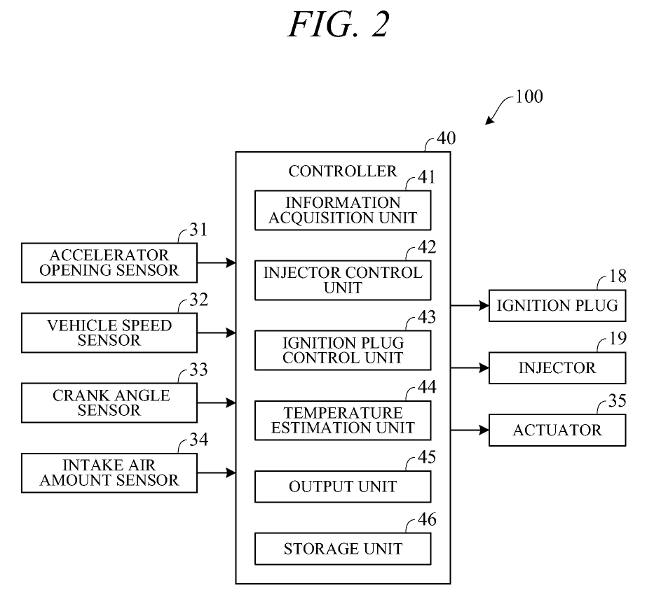

FIG. 2 is a block diagram illustrating a configuration of a main part of a control device 100 of the engine 1. The control device 100 includes the catalyst temperature estimation apparatus according to the present embodiment. As illustrated in FIG. 2, the control device 100 is configured with a controller 40 as a center, and includes an accelerator opening sensor 31, a vehicle speed sensor 32, a crank angle sensor 33, an intake air amount sensor 34, the ignition plug 18, the injector 19, and an actuator 35 each connected to the controller 40. Although not illustrated, an air-fuel ratio sensor that detects an actual air-fuel ratio, an intake pressure sensor that detects a pressure of intake air, and the like are also connected to a controller 50.

The accelerator opening sensor 31 is provided on an accelerator pedal, not illustrated, of the vehicle, and detects an operation amount (accelerator opening) on the accelerator pedal. The target torque of the engine 1 is commanded in accordance with a detection value of the accelerator opening sensor 31. That is, a torque command value is output by the accelerator opening sensor 31. The control device for the internal combustion engine according to the present embodiment can also be applied to a vehicle having a driving support function or an automated driving vehicle, and in that case, a vehicle control system outputs the torque command value to the controller 40.

The vehicle speed sensor 32 detects a vehicle speed. The crank angle sensor 33 is provided on the crankshaft 6, and is configured to output a pulse signal in accordance with the rotation of the crankshaft 6. The controller 40 identifies the rotation angle (crank angle) of the crankshaft 6 with reference to the position of the top dead center TDC at the start timing of the intake stroke of the piston 3, based on the pulse signal from the crank angle sensor 33, and also calculates the engine speed. Therefore, the crank angle sensor 33 also functions as an engine speed sensor. Hereinafter, for convenience, it is assumed that the crank angle sensor 33 detects the engine speed.

The intake air amount sensor 34 is a sensor that detects the amount of intake air to the cylinder 2, and includes, for example, an airflow meter disposed on the intake passage 13 (more specifically, upstream of the throttle valve 17). The controller 50 calculates a target injection amount of the injector 19 based on a signal from the intake air amount sensor 34. The intake air amount detected by the intake air amount sensor 34 has a correlation with the output torque of the engine 1. Therefore, the intake air amount sensor 34 also functions as a sensor that detects an engine load. The engine load (engine output torque) is calculated by the controller 40, but in the following description, for convenience, it is assumed that the intake air amount sensor 34 detects the engine load.

The actuator 35 is a throttle actuator such as an electric motor that adjusts the opening degree of the throttle valve 17. The actuator 35 is driven in accordance with the torque command value, and can control the intake air amount by adjusting a throttle opening degree through the driving of the actuator 35. That is, the intake air amount can be controlled to a target intake air amount according to the torque command value, or can be controlled to a restricted intake air amount which is more restricted than the target intake air amount. By guiding EGR gas to the intake passage through the exhaust gas recirculation device 25, the intake air amount (amount of fresh air) can also be restricted. In this case, the actuator 35 includes a throttle actuator and an EGR actuator.

A case where the intake air amount is controlled to the restricted intake air amount is when the catalyst temperature Tc is expected to exceed the upper limit temperature T1. In this case, the rise in the exhaust gas temperature is suppressed by restricting the intake air amount, whereby the catalyst temperature Tc is controlled to be equal to or lower than the upper limit temperature T1. Instead of or in addition to the restriction of the intake air amount, the fuel injection amount from the injector 19 may be relatively increased to make an air-fuel ratio rich, so that the rise in the exhaust gas temperature is suppressed and the catalyst temperature Tc may be controlled to be equal to or lower than the upper limit temperature T1.

The controller 40 includes an electronic control unit (ECU), and is configured with a computer including a calculation unit such as a CPU, a storage unit such as a ROM and a RAM, and other peripheral circuits. The controller 40 includes, as a functional configuration, an information acquisition unit 41, an injector control unit 42, an ignition plug control unit 43, a temperature estimation unit 44, an output unit 45, and a storage unit 46. Various maps, thresholds, control programs, and the like are stored in advance in the storage unit 46.

The information acquisition unit 41 reads signals from the accelerator opening sensor 31, the vehicle speed sensor 32, the crank angle sensor 33, the intake air amount sensor 34, and the like. In other words, the information acquisition unit 41 acquires information (accelerator opening, vehicle speed, intake air amount, engine speed) represented by the signals from these sensors 31 to 34. These pieces of information are parameters representing the operation state of the engine 1, and the operating point of the engine 1 on the control map, for example, the operating point determined by the engine speed and the engine load can be identified using these parameters.

The injector control unit 42 calculates the target injection amount per cycle according to the intake air amount detected by the intake air amount sensor 34 while performing feedback control such that the actual air-fuel ratio detected by the air-fuel ratio sensor becomes a target air-fuel ratio (for example, a theoretical air-fuel ratio). Then, the injector 19 is controlled to inject a target injection amount of fuel per cycle at a predetermined crank angle detected by the crank angle sensor 33. A fuel injection mode in this case is referred to as a normal injection mode.

Further, the injector control unit 42 determines whether or not the fuel cut condition is satisfied. The fuel cut condition is satisfied, for example, when a state is detected in which the operation amount (accelerator opening) of the accelerator pedal detected by the accelerator opening sensor 31 is equal to or less than a predetermined value, the engine speed detected by the crank angle sensor 33 is equal to or more than a predetermined value, and the vehicle speed detected by the vehicle speed sensor 32 is equal to or more than a predetermined value. For example, the fuel cut condition is satisfied during deceleration travel. When it is determined that the fuel cut condition is satisfied, the injector control unit 42 controls the injector 19 to stop the fuel injection. The fuel injection mode in this case is referred to as an F/C mode. Therefore, when the fuel cut condition is satisfied during the operation in the normal injection mode, the injector control unit 42 switches the fuel injection mode from the normal injection mode to the F/C mode.

The injector control unit 42 determines whether or not a fuel cut return condition is satisfied during the operation in the F/C mode. The fuel cut return condition is satisfied, for example, when a predetermined depression operation of the accelerator pedal is detected by the accelerator opening sensor 31 or when the engine speed detected by the crank angle sensor 33 decreases to a predetermined value or less. When it is determined that the fuel cut return condition is satisfied, the injector control unit 42 switches the fuel injection mode from the F/C mode to the normal mode and controls the injector 19 to restart the fuel injection.

The ignition plug control unit 43 determines a target ignition timing corresponding to the engine speed detected by the crank angle sensor 33 and the engine load (intake air amount) detected by the intake air amount sensor 34, by using a map indicating a relationship between the engine speed and the engine load stored in advance. Then, the ignition plug 18 is controlled to perform ignition at the target ignition timing.

The temperature estimation unit 44 estimates the catalyst temperature Tc in each of the normal injection mode and the F/C mode, based on the parameter representing the operation state of the engine 1 acquired by the information acquisition unit 41. In the normal injection mode, the temperature estimation unit 44 calculates the catalyst temperature Tc based on the engine speed detected by the crank angle sensor 33 and the intake air amount detected by the intake air amount sensor 34. For example, the catalyst temperature Tc with the engine speed and the intake air amount as parameters is calculated using a map stored in advance or using a predetermined calculation formula. The catalyst temperature Tc increases as the engine speed increases and as the intake air amount increases.

In the normal injection mode, in addition to the estimation of the catalyst temperature Tc, the temperature estimation unit 44 calculates an intake air amount (referred to as a combustion integrated intake air amount) G0 obtained by integrating the intake air amount detected by the intake air amount sensor 34 after the start of the normal injection mode. The combustion integrated intake air amount G0 is constantly updated, and gradually increases with the lapse of time after the start of the normal injection mode. Further, when the fuel injection mode is switched to the F/C mode, the temperature estimation unit 44 calculates a correction coefficient α based on the combustion integrated intake air amount G0, and multiplies the correction coefficient α by a predetermined intake air amount Gα to calculate a threshold G1. The predetermined intake air amount Gα is a reference value of the integrated intake air amount stored in advance in the storage unit 46. The predetermined intake air amount Gα is obtained in advance by experiment or analysis.

FIG. 3 is a diagram illustrating a relationship between the combustion integrated intake air amount G0 and the correction coefficient α stored in advance in the storage unit 46. As illustrated in FIG. 3, the correction coefficient α is 0 when the combustion integrated intake air amount G0 is less than a predetermined value G01. The correction coefficient α gradually increases with the increase in the combustion integrated intake air amount G0 when the combustion integrated intake air amount G0 becomes equal to or greater than the predetermined value G01, and becomes 1 when the combustion integrated intake air amount G0 becomes equal to or greater than a predetermined value G02. The temperature estimation unit 44 calculates the correction coefficient α by using the relationship of FIG. 3, and then multiplies the predetermined intake air amount Gα by the correction coefficient α to calculate the threshold G1. The combustion integrated intake air amount G0 is reset to 0 every time the normal injection mode ends.

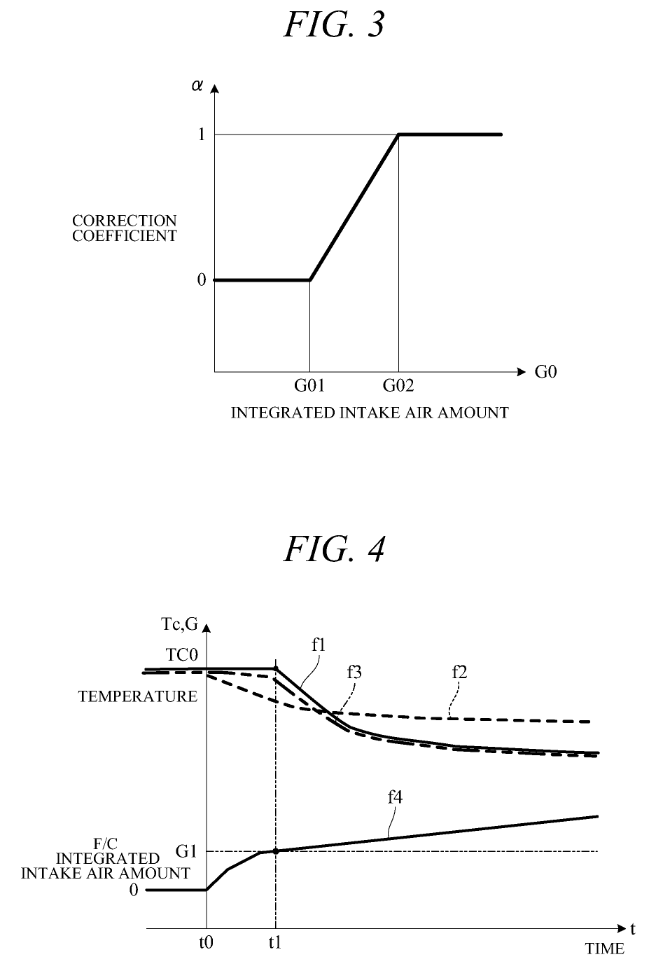

In the F/C mode, the temperature estimation unit 44 estimates the catalyst temperature Tc in a manner different from that in the normal injection mode. FIG. 4 is a diagram illustrating a change in an estimated value of the catalyst temperature Tc and the integrated intake air amount with the lapse of time after switching to the F/C mode at time point t0. In the drawing, a characteristic f1 (solid line) is the catalyst temperature Tc estimated by the temperature estimation unit 44, and a characteristic f2 (dotted line) is the catalyst temperature Tc as a reference example. The catalyst temperature Tc as a reference example is a catalyst temperature calculated by the same method as in the normal injection mode. A characteristic f3 (two-dot chain line) in the drawing corresponds to the actual catalyst temperature Tc separately obtained by experiment or analysis.

As illustrated in FIG. 4, in the present embodiment, it is estimated that the catalyst temperature Tc is constant (Tc0) from the start of the F/C mode to time point t1 at which a predetermined condition is satisfied. That is, immediately after the fuel cut, the catalyst itself is in a state of retaining heat. In addition, from time point t0 to time point t1, there is heat generation due to a catalytic reaction which is caused by a delay of intake air after the throttle valve 17 is closed due to the start of the F/C mode. Therefore, the actual catalyst temperature Tc (two-dot chain line) does not decrease immediately after the start of the fuel cut, but is constant or substantially constant. In consideration of this point, the temperature estimation unit 44 maintains the catalyst temperature Tc0 during the fuel cut as the estimated value of the catalyst temperature Tc until a predetermined condition is satisfied.

In the F/C mode, the temperature estimation unit 44 calculates an integrated intake air amount (referred to as an F/C integrated intake air amount) G2 obtained by integrating the intake air amount detected by the intake air amount sensor 34 from the start of the F/C mode. A characteristic f4 (solid line) in FIG. 4 is a characteristic of the F/C integrated intake air amount G2. The F/C integrated intake air amount G2 is constantly updated and increases with the lapse of time from the start of the F/C mode. More specifically, the F/C integrated intake air amount G2 is 0 before the start of the F/C mode, and gradually increases with the lapse of time when the F/C mode is started. The rate of increase in the F/C integrated intake air amount G2 (a slope of the characteristic f4) increases immediately after switching to the F/C mode, and gradually decreases with the lapse of time. The F/C integrated intake air amount G2 is reset to 0 every time the F/C mode ends.

FIG. 4 illustrates an example in which a predetermined condition is satisfied at time point t1. The predetermined condition is that the F/C integrated intake air amount G2 becomes equal to or greater than the threshold G1. When the F/C mode is started, the temperature estimation unit 44 determines whether or not G2 ≥ G1 is satisfied, and when G2 < G1, calculates, as the catalyst temperature Tc, a catalyst temperature Tc0 during the fuel cut as it is (time points t0 to t1).

When it is determined that G2 ≥ G1, the temperature estimation unit 44 calculates the catalyst temperature Tc based on the engine speed detected by the crank angle sensor 33 and the intake air amount detected by the intake air amount sensor 34 (time point t1). For example, the catalyst temperature Tc with the engine speed and the intake air amount as parameters is calculated using a map stored in advance or using a predetermined calculation formula. The catalyst temperature Tc decreases as the engine speed decreases and as the intake air amount increases. After the predetermined condition is satisfied, the catalyst temperature Tc gradually decreases.

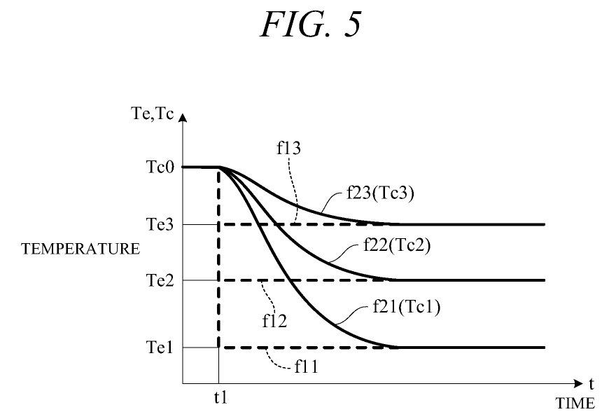

FIG. 5 is a diagram illustrating a change with the lapse of time in the catalyst temperature Tc estimated by the temperature estimation unit 44 after time point t1 at which a predetermined condition is satisfied. The characteristics f11 to f13 (dotted lines) in the drawing are characteristics indicating attainment temperatures Te of the catalyst corresponding to different operation states, and the characteristics f21 to f23 (solid lines) are characteristics indicating the catalyst temperatures Tc. The attainment temperature Te is an estimated value of the catalyst temperature Tc that the catalyst temperature is estimated to attain when a predetermined operation state (the intake air amount or the engine speed) continues after the fuel cut, and corresponds to a convergence value when the catalyst temperature Tc converges with the lapse of time.

For example, the characteristic f11 in FIG. 5 is a characteristic of an attainment temperature Te1 corresponding to a first intake air amount, the characteristic f12 is a characteristic of an attainment temperature Te2 corresponding to a second intake air amount smaller than the first intake air amount, and the characteristic f13 is a characteristic of an attainment temperature Te3 corresponding to a third intake air amount smaller than the second intake air amount. The characteristic f21 is a characteristic of a catalyst temperature Tc1 corresponding to the first intake air amount, the characteristic f22 is a characteristic of a catalyst temperature Tc2 corresponding to the second intake air amount, and the characteristic f23 is a characteristic of a catalyst temperature Tc3 corresponding to the third intake air amount. The first intake air amount, the second intake air amount, and the third intake air amount are intake air amounts detected by the intake air amount sensor 34 during the fuel cut.

The storage unit 46 stores in advance a relationship between the operation state of the engine 1 (the intake air amount and the engine speed) after the fuel cut and the attainment temperature Te. Since the catalyst is cooled by the intake air, the cooling effect of the catalyst is enhanced as the intake air amount increases. In addition, the rise in the catalyst temperature due to the compression heat is suppressed as the engine speed decreases. In consideration of this point, the storage unit 46 stores a relationship in which the attainment temperature Te decreases as the intake air amount increases and the engine speed decreases. This relationship can be obtained in advance by experiment or analysis. The temperature estimation unit 44 calculates the attainment temperature Te (Te1 to Te3) corresponding to the operation state by using this relationship stored in the storage unit 46.

The actual catalyst temperature Tc does not immediately reach the attainment temperature Te after the fuel cut, and gradually approaches the attainment temperature Te with the lapse of time. In this regard, the temperature estimation unit 44 calculates the catalyst temperature Tc by performing smoothing processing based on the attainment temperature Te. More specifically, the catalyst temperature Tc is calculated by performing smoothing processing such that the rate of decrease in the catalyst temperature Tc increases as the attainment temperature Te decreases, that is, as the intake air amount increases and the engine speed decreases. When the rates of decrease in the catalyst temperatures Tc1 to Tc3 by the characteristics f21 to f23 are expressed by ΔTc1, ΔTc2, and ΔTc3, respectively, a relationship of ΔTc1 > ΔTc2 > ΔTc3 is established as illustrated in FIG. 5.

The output unit 45 outputs a control signal to the actuator 35 so that the catalyst temperature Tc estimated by the temperature estimation unit 44 becomes equal to or lower than the upper limit temperature T1. For example, when the catalyst temperature Tc becomes a predetermined value or more, the actuator 35 is controlled such that the intake air amount becomes a restricted intake air amount which is restricted more than the target intake air amount corresponding to the accelerator opening (torque command value). Accordingly, the rise in the catalyst temperature Tc is suppressed, and the catalyst temperature Tc can be restricted to the upper limit temperature T1 or less. When the catalyst temperature Tc becomes equal to or higher than a predetermined value, the output unit 45 may output a control signal to the injector 19 to relatively increase the fuel injection amount to make the air-fuel ratio rich. The rise in the catalyst temperature Tc can be suppressed not only by controlling the intake air amount but also by controlling the fuel injection amount.

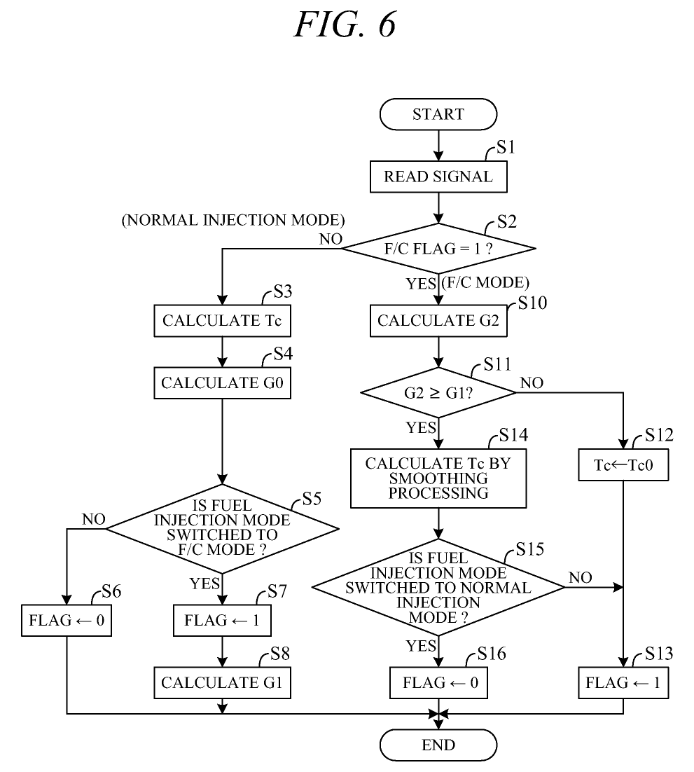

FIG. 6 is a flowchart mainly illustrating an example of processing executed by the CPU of the controller 40, particularly, an example of processing related to estimation of the catalyst temperature Tc in the temperature estimation unit 44. The processing illustrated in the flowchart starts, for example, with turning on the engine switch, and repeats at predetermined cycles.

As illustrated in FIG. 6, first, in S1 (S: processing step), the controller 40 reads signals from the crank angle sensor 33 and the intake air amount sensor 34. Further, the controller 40 reads a signal from the injector control unit 42, that is, a signal indicating switching of the fuel injection mode. Next, in S2, the controller 40 determines whether or not an F/C flag is 1. The F/C flag is set to 1 in the F/C mode and set to 0 in the normal injection mode.

When a negative determination is made in S2, the process proceeds to S3, and the controller 40 calculates the catalyst temperature Tc based on the engine speed detected by the crank angle sensor 33 and the intake air amount detected by the intake air amount sensor 34. Next, in S4, the controller 40 calculates the combustion integrated intake air amount G0 obtained by integrating the intake air amount detected by the intake air amount sensor 34 from the start of the normal injection mode.

Next, in S5, the controller 40 determines whether or not the fuel injection mode has been switched from the normal injection mode to the F/C mode, based on a signal from the injector control unit 42. When a negative determination is made in S5, the process proceeds to S6, and the controller 40 sets the flag to 0 and ends the process.

When an affirmative determination is made in S5, the process proceeds to S7, and the controller 40 sets the flag to 1. Next, in S8, the controller 40 calculates the correction coefficient α corresponding to the combustion integrated intake air amount G0 calculated in S4, based on the characteristic of FIG. 3. Further, the controller 40 multiplies the predetermined intake air amount Gα by the correction coefficient α to calculate the threshold G1, stores the threshold G1 in the storage unit 46, and ends the process. When the threshold G1 is calculated, the controller 40 resets the combustion integrated intake air amount G0.

When it is determined in S2 that the F/C flag is 1, the process proceeds to S10, and the controller calculates the F/C integrated intake air amount G2 obtained by integrating the intake air amount detected by the intake air amount sensor 34 from the start of the F/C mode. Next, in S11, the controller 40 determines whether or not the F/C integrated intake air amount G2 is equal to or greater than the threshold G1.

When a negative determination is made in S11, the process proceeds to S12, and the controller 40 maintains, as the catalyst temperature Tc, the latest catalyst temperature Tc0 calculated in S3, that is, the catalyst temperature Tc0 when the fuel injection mode is switched to the F/C mode. Next, in S13, the flag is set to 1, and the process ends.

On the other hand, when an affirmative determination is made in S11, the process proceeds to S14, and the controller 40 calculates the attainment temperature Te corresponding to the operation state of the engine 1 after the fuel cut. That is, the attainment temperature Te corresponding to the intake air amount detected by the intake air amount sensor 34 and the engine speed detected by the crank angle sensor 33 is calculated. Further, the controller 40 calculates the catalyst temperature Tc by performing smoothing processing such that the catalyst temperature Tc gradually approaches the attainment temperature Te with the lapse of time.

Next, in S15, the controller 40 determines whether or not the fuel injection mode has been switched from the F/C mode to the normal injection mode, based on a signal from the injector control unit 42. When a negative determination is made in S15, the process proceeds to S13, and when an affirmative determination is made, the process proceeds to S16. In S16, the controller 40 sets the flag to 0 and ends the process. At this time, the controller 40 resets the F/C integrated intake air amount G2.

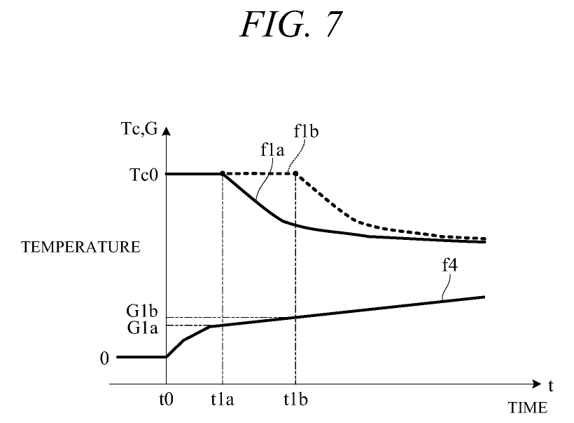

The operation of the catalyst temperature estimation apparatus according to the present embodiment is summarized as follows. In the normal injection mode, the catalyst temperature Tc is calculated according to the operation state of the engine 1 (engine speed, intake air amount) (S3). FIG. 7 is a diagram illustrating an example of a change with the lapse of time in the estimated value of the catalyst temperature Tc and the F/C integrated intake air amount G2. When the fuel injection mode is switched to the F/C mode at time point t0 in FIG. 7, the estimated value of the catalyst temperature Tc is maintained at the catalyst temperature Tc0 at time point t0 when the mode is switched to the F/C mode.

That is, immediately after the fuel cut, the catalyst itself is in a state of retaining heat, and in the exhaust gas purification device 20, there is heat generation due to a catalytic reaction which is caused by a delay of intake air after the throttle valve 17 is closed. Therefore, when the catalyst temperature Tc is calculated according to the operation state of the engine 1 immediately after the fuel cut, the calculated catalyst temperature Tc becomes lower than the actual catalyst temperature Tc, and the accuracy of the temperature estimation deteriorates. In this regard, in the present embodiment, since the catalyst temperature Tc is kept constant (Tc0) immediately after the fuel cut, the catalyst temperature Tc can be accurately estimated.

The time during which the catalyst temperature Tc is kept constant is determined according to the threshold G1 before the fuel cut. When the threshold G1 is a predetermined value G1a in FIG. 7, as indicated by a characteristic f1a (solid line), the smoothing processing of the catalyst temperature Tc is started at time point t1a, and the estimated value of the catalyst temperature Tc gradually decreases (S14). On the other hand, when the threshold G1 is a predetermined value G1b in FIG. 7, as indicated by a characteristic f1b (dotted line), the smoothing processing of the catalyst temperature Tc is started at time point t1b after time point t1a. That is, as the threshold G1 increases, the start of the smoothing processing is delayed, and the time during which the catalyst temperature Tc is kept constant is lengthened.

The threshold G1 affects the heating state of the catalyst, and as the threshold G1 increases, the catalyst temperature Tc is less likely to decrease. The threshold G1 is calculated by multiplying the predetermined intake air amount Gα by the correction coefficient α, and the correction coefficient α increases as the integrated intake air amount G0 before the fuel cut increases (FIG. 3). Accordingly, since the catalyst temperature Tc is calculated in consideration of the heating state of the catalyst before the fuel cut, the catalyst temperature Tc can be accurately estimated.

The smoothing processing of the catalyst temperature Tc is processing in which, based on the attainment temperature Te of the catalyst temperature Tc set according to the operation state of the engine 1, the rate of decrease in the catalyst temperature Tc is increased as the attainment temperature Te decreases (FIG. 5). Therefore, as the intake air amount increases and the engine speed decreases after the fuel cut, the attainment temperature Te decreases, and the rate of decrease in the calculated catalyst temperature Tc increases. This makes it possible to accurately estimate the catalyst temperature Tc not only immediately after the fuel cut but also after a predetermined condition is satisfied after the fuel cut (after time points t1a and t1b in FIG. 7).

According to the present embodiment, the following operations and effects are achievable.

(1) A catalyst temperature estimation apparatus is configured to estimate a catalyst temperature Tc of an exhaust gas purification device 20 provided in an exhaust passage 14 in an engine 1 that includes an injector 19 that injects fuel and has a fuel cut function of cutting off fuel injection from the injector 19 while a vehicle is traveling (FIG. 1). The catalyst temperature estimation apparatus includes an information acquisition unit 41 that acquires a parameter (an intake air amount, an engine speed, and the like) representing an operation state of the engine 1, and a temperature estimation unit 44 that obtains an estimated value of the catalyst temperature Tc based on the parameter acquired by the information acquisition unit 41 (FIG. 2). When the fuel cut is executed, the temperature estimation unit 44 maintains an estimated value (Tc0) at start of the fuel cut until the operation state after the fuel cut becomes a predetermined operation state (until a predetermined condition is satisfied), specifically, until an F/C integrated intake air amount G2 becomes equal to or greater than a threshold G1 (FIGS. 4 and 6).

Accordingly, the catalyst temperature Tc after the fuel cut can be accurately estimated. That is, immediately after the fuel cut, a catalyst itself is in a state of retaining heat, and there is also heat generation due to a catalytic reaction which is caused by supply of air to the exhaust gas purification device 20. Therefore, if, after the fuel cut, the catalyst temperature Tc is calculated using the same method as before the fuel cut, it is difficult to accurately calculate the catalyst temperature Tc. In this regard, in the present embodiment, by maintaining the estimated value of the catalyst temperature Tc at the start of fuel cut until a predetermined condition is satisfied after the fuel cut, the catalyst temperature Tc (characteristic f1) can be accurately estimated in accordance with the actual catalyst temperature (characteristic f3) as illustrated in FIG. 4.

(2) The information acquisition unit 41 acquires information on the intake air amount of the engine 1 detected by the intake air amount sensor 34 (FIG. 2). The temperature estimation unit 44 calculates an F/C integrated intake air amount G2 that is an integrated value of the intake air amount from the start of the fuel cut, based on the information on the intake air amount acquired by the information acquisition unit 41, and maintains the estimated value (Tc0) at the start of the fuel cut until the F/C integrated intake air amount G2 reaches the threshold G1 (FIGS. 4 and 6). After the fuel cut, the catalyst is cooled by the intake air, but in a state where the intake air amount is small, a decrease in the catalyst temperature is small. Since the catalyst temperature Tc is estimated in consideration of this point, the catalyst temperature Tc after the fuel cut can be accurately estimated.

(3) The temperature estimation unit 44 further calculates a combustion integrated intake air amount G0 that is an integrated value of the intake air amount before the fuel cut, and sets the threshold G1 based on the combustion integrated intake air amount G0 (FIG. 3). Before the fuel cut, the catalyst is heated by the exhaust gas, but in a state where an exhaust amount is large, the catalyst retains a large amount of heat. Since the catalyst temperature Tc is estimated in consideration of this point, the catalyst temperature Tc after the fuel cut can be accurately estimated.

(4) The temperature estimation unit 44 increases the correction coefficient α and sets the threshold G1 to a larger value as the combustion integrated intake air amount G0 increases (FIG. 3). Accordingly, the correction coefficient α for calculating the threshold G1 to be compared with the F/C integrated intake air amount G2 can be appropriately set, and the estimation accuracy of the catalyst temperature Tc is enhanced.

(5) The temperature estimation unit 44 calculates the attainment temperature Te that the catalyst temperature Tc is estimated to attain, based on the parameter acquired by the information acquisition unit 41. Further, after the fuel cut is performed, and then the F/C integrated intake air amount G2 reaches the threshold G1, the temperature estimation unit 44 obtains the estimated value of the catalyst temperature Tc by performing smoothing processing toward the attainment temperature Te such that the rate of decrease in the temperature per unit time increases as the attainment temperature Te decreases (FIG. 5). Accordingly, the catalyst temperature Tc that decreases after the fuel cut can be accurately estimated.

(6) The information acquisition unit 41 acquires information on the intake air amount of the engine 1 detected by the intake sensor 34 and information on the speed of the engine 1 detected by the crank angle sensor 33 (FIG. 2). The temperature estimation unit 44 obtains the estimated value of the catalyst temperature Tc after the F/C integrated intake air amount G2 reaches the threshold G1, by performing smoothing processing in which the rate of decrease in the temperature per unit time increases as the intake air amount included in the information acquired by the information acquisition unit 41 increases and/or as the engine speed included in the information acquired by the information acquisition unit 41 decreases (FIG. 5). The cooling effect of the catalyst is enhanced as the intake air amount increases, and the rise in the catalyst temperature due to the compression heat is suppressed as the engine speed decreases. However, since the smoothing processing is performed in consideration of this point, the catalyst temperature Tc can be accurately estimated by the smoothing processing.

(7) The information acquisition unit 41 acquires information on the intake air amount of the engine 1 detected by the intake sensor 34 and information on the speed of the engine 1 detected by the crank angle sensor 33 (FIG. 2). The temperature estimation unit 44 calculates the attainment temperature Te such that the attainment temperature Te decreases as the intake air amount included in the information acquired by the information acquisition unit 41 increases and/or as the engine speed included in the information acquired by the information acquisition unit 41 decreases (FIG. 5). Accordingly, the attainment temperature Te of the catalyst temperature Tc can be favorably calculated, and the catalyst temperature can be accurately estimated by the smoothing processing.

The above embodiment can be modified to various forms. Hereinafter, some modified examples will be described. In the above embodiment, the injector 19 functioning as a fuel injection part injects fuel directly into the combustion chamber 4, but it may be configured as a port injection type that injects fuel into the intake port instead of or in addition to the direct injection type. In the above embodiment, the engine 1 is configured to have a fuel cut function that cuts off the fuel injected from the injector 19 when a predetermined fuel cut condition is met during engine operation. However, the fuel cut condition is not limited to those mentioned above, nor is the configuration of an internal combustion engines having the fuel cut function limited to those mentioned above.

In the above embodiment, the information acquisition unit 41 is configured to acquire parameters representing the operation state of the engine 1, such as intake air amount and engine speed. However, the configuration of an operation state acquisition unit is not limited to those mentioned above. That is, the operation state acquisition unit may be other than an intake information acquisition unit that acquires information on an intake air amount and a rotational information acquisition unit that acquires information on a rotational speed of the internal combustion engine. In the above embodiment, when the fuel cut is performed, the estimated value of the catalyst temperature Tc at the time of fuel cut start is maintained until the F/C integrated intake air amount value G2 (a first integrated value), which is the integrated value of the intake air amount from the fuel cut start, reaches the threshold G1 or more. That is, the estimated value at the time of fuel cut start is maintained until a predetermined condition G2 ≥ G1 is satisfied after the fuel cut, but the predetermined condition is not limited to the above one. Therefore, the configuration of the temperature estimation unit 44 can be of any type as long as the estimated value at the time of fuel cut start is maintained until the operation state after fuel cut reaches a predetermined operation state.

In the above embodiment, the temperature estimation unit 44 calculates the combustion integrated intake air amount G0 (a second integrated value), which is the integrated value of the intake air amount before the fuel cut, and sets the threshold G1 (a predetermined value) based on the integrated value. More specifically, the larger the combustion integrated intake air amount G0, the larger the predetermined value for comparison with the F/C integrated intake air amount G2 is set, but this predetermined value is not limited to the one described above. In the above embodiment, the attainment temperature Te to which the catalyst temperature is estimated to reach after the fuel cut is calculated, and based on this attainment temperature Te, the catalyst temperature Tc is estimated. However, the catalyst temperature Tc may also be estimated without using the attainment temperature Te.

In the above embodiment, a smoothing processing is performed such that after the fuel cut, the greater the intake air amount and the smaller the engine speed (a rotational speed), the larger the rate of temperature decrease per unit time after the fuel cut. However, it may also be configured that as the intake air amount increases or the rotational speed decreases, the rate of temperature decrease per unit of time increases. In the above embodiment, the attainment temperature Te decreases as the intake air amount increases and the engine speed decreases. However, the attainment temperature Te may decrease as the intake air amount increases or the engine speed decreases.

The above embodiment can be combined as desired with one or more of the above modifications. The modifications can also be combined with one another.

According to the present invention, it is possible to precisely estimate a catalyst temperature after fuel cut.

Above, while the present invention has been described with reference to the preferred embodiments thereof, it will be understood, by those skilled in the art, that various changes and modifications may be made thereto without departing from the scope of the appended claims.

What is claimed is:

1. A catalyst temperature estimation apparatus estimating a catalyst temperature of an exhaust gas purification device, the exhaust gas purification device being disposed in an exhaust passage of an internal combustion engine, the internal combustion engine including an injector injecting a fuel and having a function of a fuel cut configured to shut off a fuel injection from the injector while a vehicle is traveling,
the catalyst temperature estimation apparatus comprising
an electronic control unit including a microprocessor and a memory connected to the microprocessor, wherein
the microprocessor is configured to perform
acquiring a parameter representing an operation state of the internal combustion engine, and
obtaining an estimated value of the catalyst temperature based on the parameter,
the obtaining including maintaining the estimated value at a start of the fuel cut until the operation state after the fuel cut becomes a predetermined operation state when the fuel cut is executed.

2. The catalyst temperature estimation apparatus according to claim 1, wherein
the microprocessor is configured to perform
the acquiring including acquiring information on an intake air amount of the internal combustion engine, and
the obtaining including calculating an integrated value of the intake air amount from the start of the fuel cut based on the information on the intake air amount, and maintaining the estimated value at the start of the fuel cut until the integrated value reaches a predetermined value.

3. The catalyst temperature estimation apparatus according to claim 2, wherein
the integrated value is a first integrated value, and
the microprocessor is configured to perform
the obtaining including further calculating a second integrated value defined as an integrated value of the intake air amount before the start of the fuel cut, and setting the predetermined value based on the second integrated value.

4. The catalyst temperature estimation apparatus according to claim 3, wherein
the microprocessor is configured to perform
the obtaining including setting the predetermined value to be larger as the second integrated value increases.

5. The catalyst temperature estimation apparatus according to claim 4, wherein
the memory is configured to store a characteristic representing a relationship between the second integrated value and a correction coefficient in advance, the characteristic being defined such that when the second integrated value is less than a first predetermined value, the correction coefficient is 0; when the second integrated value is equal to or more than the first predetermined value and less than a second predetermined value, the correction coefficient gradually increases with an increase in the second integrated value; and when the second integrated value is equal to or more than the second predetermined value, the correction coefficient is 1, and
the microprocessor is configured to perform
the obtaining including calculating the correction coefficient corresponding to the second integrated value based on the characteristic, and setting the predetermined value by multiplying the correction coefficient with a predetermined reference value of the second integrated value.

6. The catalyst temperature estimation apparatus according to claim 2, wherein
the microprocessor is configured to perform
the obtaining including calculating an attainment temperature to which the catalyst temperature is estimated to reach, based on the parameter, assuming that the predetermined operation state continues after the fuel cut, and calculating the estimated value of the catalyst temperature by performing a smoothing processing in which, after the integrated value reaches the predetermined value, the estimated value decreases toward the attainment temperature such that a rate of decrease in the estimated temperature per a unit time increases as the attainment temperature decreases.

7. The catalyst temperature estimation apparatus according to claim 6, wherein
the microprocessor is configured to perform
the acquiring including acquiring information on a rotational speed of the internal combustion engine, and
the obtaining including obtaining the estimated value by performing the smoothing processing such that, after the integrated value reaches the predetermined value, the rate of decrease in the estimated temperature per the unit time increases as the intake air amount increases or the rotational speed decreases.

8. The catalyst temperature estimation apparatus according to claim 6, wherein
the microprocessor is configured to perform
the acquiring including acquiring information on a rotational speed of the internal combustion engine, and
the obtaining including calculating the attainment temperature such that the attainment temperature decreases as the intake air amount increases or the rotational speed decreases.

9. The catalyst temperature estimation apparatus according to claim 1, further comprising:
an intake air amount sensor configured to detect an intake air amount sucked into the internal combustion engine; and
a rotational speed sensor configured to detect a rotational speed of the internal combustion engine, wherein
the microprocessor is configured to perform
the obtaining including obtaining the estimated value of the catalyst temperature at the start of the fuel cut based on signals from the intake air amount sensor and the rotational speed sensor.

10. A control apparatus for an international combustion engine, the internal combustion engine including an injector injecting a fuel and having a function of a fuel cut configured to shut off a fuel injection from the injector while a vehicle is traveling, the internal combustion engine further including an intake adjustment part configured to adjust an intake air amount and an exhaust gas purification device disposed in an exhaust passage,
the control apparatus comprising:
the catalyst temperature estimation apparatus according to claim 1; and
an electronic control unit including a microprocessor and a memory connected to the microprocessor, wherein
the microprocessor is configured to perform
controlling the intake adjustment part based on an estimated value of a catalyst temperature of the exhaust gas purification device estimated by the catalyst temperature estimation apparatus, and
the controlling including determining whether the estimated value of the catalyst temperature exceeds a predetermined value, and restricting the intake air amount when it is determined that the estimated value exceeds the predetermined value, more than when it is determined that the estimated value does not exceed the predetermined value.
